(19) United States
(12) Patent Application Publication
(10) Pub. No.: US 2020/0270097 A1
(43) Pub. Date: Aug. 27, 2020

(54) OPTICAL BRAKE LINING MONITORING

(71) Applicant: Inventio AG, Hergiswil (CH)

(72) Inventors: Vincent Robibero, Randolph, MA (US); Dave Kraft, Long Valley, NJ (US)

(21) Appl. No.: 16/063,753

(22) PCT Filed: Dec. 21, 2016
(86) PCT No.: PCT/EP2016/082132

§ 371 Date: Jun. 19, 2018

(30) Foreign Application Priority Data
Dec. 23, 2015 (EP) 15202258.8

(51) Int. Cl. B66B 5/00; B66B 1/32

(52) U.S. Cl. CPC B66B 5/0031; B66B 1/3492; B66B 5/0025; B66B 1/32

(57) ABSTRACT

A brake system for a passenger transportation system includes a brake lining and a brake surface, wherein a gap exists between the brake lining and the brake surface when the brake system is in an open position. The brake system also includes an optical monitoring system and a processor. The optical monitoring system has a light source arranged to emit light towards at least one of the gap and the brake lining, and a light detector arranged in a light path of the light emitted by the light source. The light detector generates an electrical signal as a function of impinging light. The processor is coupled to the optical monitoring system to receive the electrical signal and to generate a predetermined indication if the signal indicates a value that is equal to or greater than a predetermined threshold value.

### FIELD

The present disclosure of various embodiments generally relates to a brake system in which a friction material is urged against a contact surface during braking. More particularly, the various embodiments described herein relate to a system and method of monitoring wear of the friction material, in particular in a brake system of passenger transportation system, such as an elevator, escalator or moving walk.

### BACKGROUND

An elevator brake system, for example, either including a drum brake or a disk brake, typically is provided to halt rotation of a motor shaft in an elevator installation, such as a traction elevator. In either case, at least one compression spring is generally employed to bias the brake into a closed or braking position, and an actuator which is typically electromagnetically, hydraulically or pneumatically driven is provided to overcome the spring bias and move the brake into an open or released position. In the open position, the motor is permitted to commence rotation and thereby raise or lower an elevator car along a hoistway. In the closed position, i.e., during braking, brake linings are urged against friction surfaces to halt the rotation of the motor shaft and, hence, to stop or prevent movement of the elevator car. These brakes are regarded as fail-safe systems since if, for example, power is lost to the actuator, the brakes under the influence of the biasing springs automatically assume the braking or closed position.

In such friction-based brakes, the brake linings are subject to wear. EP 0 671 356 A1 describes an apparatus for monitoring wear of brake linings. In that apparatus, a mechanical switch is replaced by an optomechanical switch having a light barrier and a peg. The peg is in contact with a surface of a brake lining so that with changing lining thickness the peg is moved along its longitudinal axis. Initially, with a new brake lining, the peg blocks light passage. Over time, when the thickness of the brake lining decreases, the peg allows passage of light. At a set minimum thickness, the peg again blocks the passage of light.

Even though EP 0 671 356 A1 discloses an alternative to a mechanical switch for monitoring the wear of a brake lining, its optomechanical switch includes the movable peg. In general, movable parts are subject to blocking and require regular inspection or maintenance. There is, therefore, a need for an improved brake lining monitoring technology that provides for reduced inspection or maintenance requirements.

### SUMMARY

Accordingly, one aspect of such an alternative technology involves a brake system for a passenger transportation system. The brake system includes a brake lining and a brake surface, wherein a gap exists between the brake lining and the brake surface when the brake system is in an open position. The brake system includes also an optical monitoring system and a processor. The optical monitoring system has a light source arranged to emit light towards at least one of the gap and the brake lining, and a light detector arranged in a light path of the light emitted by the light source. The light detector generates an electrical signal as a function of impinging light. The processor is coupled to the optical monitoring system to receive the electrical signal and to generate a predetermined indication if the signal indicates a value that is equal to or greater than a predetermined threshold value Vₘₐₓ.

Another aspect of the alternative technology involves a method of monitoring a brake system of a passenger transportation system. The brake system includes a brake lining, and a brake surface, wherein a gap exists between the brake lining and the brake surface when the brake system is in an open position. According to that method, a light source of an optical monitoring system is activated to emit light towards at least one of the gap and the brake lining. An electrical signal is generated by a light detector arranged in a light path of the light emitted by the light source and belonging to the optical monitoring system, wherein the electrical signal is generated as a function of impinging light. A predetermined indication is generated by a processor if the electrical signal indicates a value that is equal to or greater than a predetermined threshold value Vₘₐₓ.

The technology provides an optoelectronic monitoring method that avoids moving parts. Once installed and adjusted the optical monitoring system can be used for various monitoring procedures, for example, for continuous monitoring or monitoring according to a predetermined schedule or event. The processing of signals can be performed locally within the brake system or within a controller of the passenger transportation system. These aspects allow flexibility regarding how to implement the brake monitoring without having a service technician to inspect the brake system on-site.

The technology not only provides for flexibility, but also for a high degree of safety. In one embodiment, operation of the passenger transportation system may be stopped in response to the processor generating the indication. As described herein, such an indication may indicate a worn brake lining. In another embodiment, a service request message may be generated in response to generating the indication. It is contemplated that a service request message may be generated in response to stopping of the passenger transportation system.

The technology allows also flexibility regarding the optical monitoring system, for example, to adapt to specific space limitations. That is, the monitoring system may use direct light or reflected light. In one embodiment, light passes through the gap to impinge (directly) on the light detector, wherein the light source and the light detector are located on opposite sides of the gap. Alternatively, in another embodiment, the light source and the light detector may by arranged on the same side of the gap, and a reflector is used to reflect light back through the gap towards the light detector. This may be advantageous if there is not enough room, or if it is impractical, to position the light source and light detector on opposite sides.

In yet another embodiment, the brake lining has an edge region at a front (wear) side of the brake lining that acts upon the brake surface, wherein the source and the light detector are arranged in proximity of the edge region. The light source emits light towards the edge region that reflects the light towards the light detector. The light detector generates the electrical signal as a function of the reflected light. As the brake lining wears with use, the area of the reflective surface on the edge region of the lining will reduce, which will in turn reduce the reflected light from the edge surface. This embodiment is an alternative to passing light through the gap which in certain passenger transportation systems might be impractical. Yet, this embodiment provides for the advantages of the optoelectronic monitoring.

In certain embodiments, the edge region includes one of a polished surface and a surface with applied reflective material. The surface of the edge region may be configured to have a gradient reflective surface.

Light used in a brake application may be subject to interferences and inaccuracies caused by ambient light, dust or particles in the path between the light source and the light detector. To minimize these effects, various modulation techniques may be used. In one embodiment, the processor generates a drive signal having a predetermined frequency to drive the light source to emit light that is modulated according to the predetermined frequency. The processor further operates the light detector to detect light according to the predetermined frequency.

The technology described herein may not only be used for monitoring the wear of brake linings, but may further be used to provide input signals to the brake controller. In one embodiment, the electrical signal is determined when the brake system is in a fully closed position. That electrical signal is then used to control supply of electrical power to a drive.

In another embodiment, the brake system can be set to indicate a partially open position. In that position, the electrical signal can be determined and used to coordinate buildup of motor torque.

The skilled person will appreciate that the technology is not limited to a particular type of brake system. The technology can in particular be used in a drum brake, where the brake surface is a lateral surface of a cylinder-shaped brake disk, or in a disk brake where the brake surface is a cap surface of the cylinder-shaped brake disk.

### DESCRIPTION OF THE DRAWINGS

The novel features and method steps characteristic of the technology are set out below. The various embodiments of the technology, however, as well as other features and advantages thereof, are best understood by reference to the detailed description, which follows, when read in conjunction with the accompanying drawings, wherein:

FIG. 1 shows a schematic illustration of an exemplary application of a first embodiment of a braking system in an elevator installation;

FIG. 2a shows a schematic illustration of a plan view of a second embodiment of a service brake;

FIG. 2b shows a schematic illustration of a side view of the service brake of FIG. 2a;

FIG. 3 is a schematic illustration of a further embodiment of an optical monitoring system based on detecting light reflected on a reflector;

FIG. 4 is a schematic graph illustrating a voltage as a function of a width of a gap;

FIG. 5 is a flow diagram of one embodiment of a method of monitoring a braking system; and

FIG. 6 is a schematic illustration of one embodiment of an optical monitoring system based on detecting light reflected on a brake lining.

### DETAILED DESCRIPTION

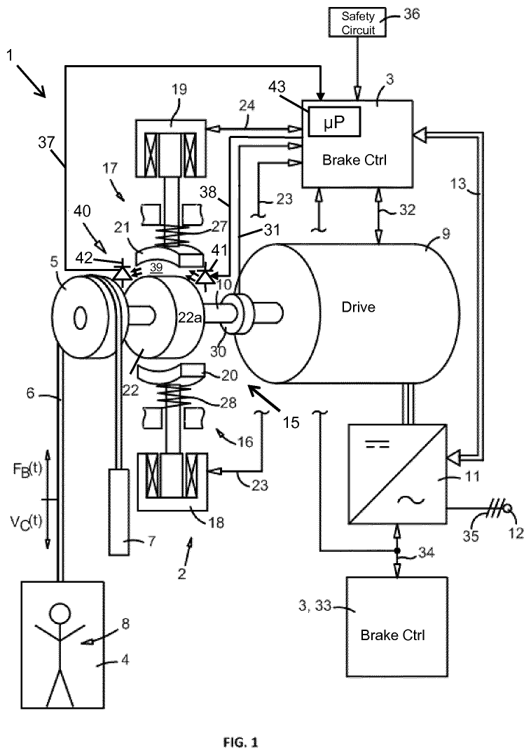

FIG. 1 shows a schematic illustration of one embodiment of a passenger transportation system 1. This passenger transportation system 1 is embodied as an elevator or elevator system 1, with a driving and braking system 2, and a brake control 3. It is contemplated that in a correspondingly modified embodiment, the passenger transportation system 1 can also be embodied as an escalator or moving walk. The driving and braking system 2, as well as the brake control 3, serve passenger transportation systems 1 which are embodied as elevator, escalator, or moving walk. It is contemplated, however, that the brake monitoring system described herein is also applicable in brake systems for other applications.

Referring initially to the braking function of the passenger transportation system 1, and describing several of its other components and functions thereafter below, the driving and braking system 2 has a brake system 15, hereinafter referred to as service brake 15, with brake units 16, 17. The brake units 16, 17 each have an actor 18, 19 connected to the brake control 3 by respective signal lines 23, 24. The actors 18, 19 are embodied, for example, as electromagnetic actors 18, 19. For safety reasons, the actors 18, 19, and the service brake 15, are energized for as long as the latter must remain open. Through actuation of the actors 18, 19, or through interruption of a power-supply voltage, by means of spring elements 27, 28 brake linings 20, 21 of the brake units 16, 17 are applied to a brake surface 22a, here embodied on a lateral surface of a cylinder-shaped brake disk 22 connected to a drive shaft 10. In the illustrated embodiment, the plane of the brake surface 22a extends about parallel to the drive shaft 10. The brake disk 22 is connected to the drive shaft 10 in rotationally fixed manner. Hence, through activation of the service brake 15, a braking torque is exerted on the drive shaft 10, which causes a deceleration of, for example, an elevator car 4 shown in FIG. 1.

FIG. 1 shows the service brake 15 configured as a drum brake in an open position. In that position a gap 39, typically an air gap, exists between the lining 21 and the brake surface 22a of the brake disk 22. Although not labeled in FIG. 1, a similar gap exists between the lining 20 and the brake surface 22a of the brake disk 22. An optical monitoring system 40 is mounted to the driving and braking system 2 and coupled via conductor lines 37, 38 to the brake control 3. The optical monitoring system 40 includes a light source 41 driven by a control signal via the conductor line 38, and a light detector 42 coupled to the conductor line 37. As illustrated in FIG. 1, the light source 41 is arranged to shine light through the gap 39 towards the light detector 42. The light detector 42 is arranged to detect light passing through the gap 39.

Although the term “light” is used herein, it is contemplated that in the technology described herein visible light (i. e., light visible by a human eye), and non-visible light (e. g., infrared light) may be used. In one embodiment, the light source 41 includes one or more light emitting diodes (LED) that emit light of a desired wavelength or wavelength range. In another embodiment, the light source 41 includes one or more laser diodes emitting monochromatic laser light. Accordingly, the light detector 42 is selected to be sensitive to the light emitted by the light source 41.

The light source 41 may be driven by the brake control 3 to emit modulated or unmodulated light. Known light modulation techniques may be applied to minimize interferences and inaccuracies caused by ambient light, dust or particles in the path between the light source 41 and the light detector 42. The modulation may be direct, i. e., the drive signal (current) applied to the light source 41 causes the light modulation, or indirect (external), e. g., by use of color, phase or polarization filters. For example, to reduce inaccuracies caused by ambient light the light source 41 may emit near infrared light, and a color filter that blocks visible light may be positioned in the light path in front of the light detector 42. If direct modulation is used, the light source 41 is operated according to a selected modulation frequency to emit light impulses of known duration and sequence. The light detector 42 is operated according to the modulation frequency and, by means of a coincidence circuit, is ready-to-receive only when a light impulse can be sent, otherwise the light detector 42 is disabled. It is further possible to process the electrical signal generated by the light detector 42, e. g., to apply an electrical filter to remove any noise.

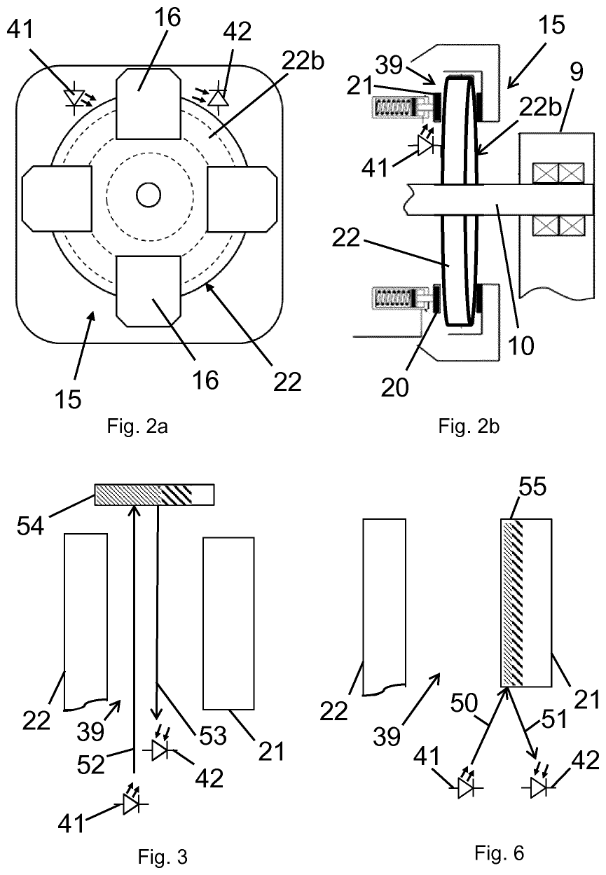

In another embodiment, the service brake 15 can be configured as a disk brake. FIG. 2a shows a schematic illustration of a plan view of such a service brake 15, and FIG. 2b shows a corresponding side view of the service brake 15. The service brake 15 has four brake units 16 (only two are labeled) as shown in FIG. 2a, each one having brake linings 20, 21. For illustrative reasons, the brake linings 20, 21 are not visible in FIG. 2a. The brake linings 20, 21 act upon a brake surface 22b, which in the illustrated embodiment is a cap surface of the cylinder-shaped brake disk 22. The plane of the brake surface 22b extends about perpendicular to the drive shaft 10. When the service brake 15 is in the open position, as illustrated in FIG. 2b, a gap 39 exists between the brake surface 22b and the brake lining 21. Similar to FIG. 1, the light source 41 is arranged so that light passes through the gap 39 (FIG. 2b) and impinges on the light detector 42.

The service brake 15 shown in FIG. 2a and FIG. 2b is hydraulically actuated. Briefly, in order to release the service brake 15, pressurised fluid is supplied via hydraulic circuits to a brake cylinder within each actuator 16. The pressurised fluid acts on one side of a brake piston to counteract a biasing force of a compression spring acting on the other side of the piston. Accordingly, as the pressure of the fluid increases, the piston moves to further compress the spring (in the left direction in FIG. 2b) and thereby releases a piston mounted brake shoe and an opposing brake shoe from engagement with the opposing sides of a brake disk 22.

FIG. 3 is a schematic illustration of a further embodiment of an optical monitoring system 40 that may be used in a drum brake (FIG. 1) and a disk brake (FIGS. 2a and 2b). For illustrative purposes, FIG. 3 shows only a brake lining 21, a brake disk 22 and components of the optical monitoring system 40. In addition to the light source 41 and the light detector 42, the optical monitoring system 40 includes a reflector 54. These components are arranged in a fixed relationship in proximity of the gap 39 to direct and detect light through the gap 39. The light source 41 and the light detector 42 are arranged on the same side of the gap 39, and the reflector 54 is arranged on an opposite side of the gap 39.

The reflector 54 has a surface that reflects light emitted by the light source 41, for example, a mirror-like surface for visible light. In one embodiment, the surface has a reflectance that is essentially uniform across the width of the gap 39. In another embodiment, the reflectance across the width of the gap 39 is non-uniform; for example, it may change with a (linear or nonlinear) gradient from a high reflectance in proximity of the brake disk 22 to a lower reflectance towards the brake lining 21. FIG. 3 shows this optional gradient through differently hatched areas of the reflector 54.

In the embodiment of FIG. 3, while the service brake 15 is in the open position, light emitted from the light source 41 passes through the gap 39, impinges on the reflector 54 and passes in opposite direction through the gap to impinge on the light detector 42. Light emitted from the light source 41 is indicated through an arrow 52, and reflected light is indicated through an arrow 53. In the fully closed position, however, the brake lining 21 blocks the light path. Referring to the illustrated open position, the gap 39 is the smallest while the brake lining 21 is new and the least amount of reflected light passes through the gap 39. In this case, the light detector 42 detects the lowest light intensity. As the brake lining 21 wears or is worn over time, the gap 39 widens in the open position and more light is reflected back to the light detector 42. In this case, the light intensity detected by the light detector 42 increases over time.

In the illustrations of FIGS. 1, 2a, 2b, 3 and 6 (described below) one pair of a light source 41 and a light detector 42 is arranged at the service brake 15. It is contemplated, however, that more than one of such pairs can be arranged. For example, the number of pairs may depend on the number of brake linings used in the service brake 15. Referring to the embodiment of FIG. 2a, for example, four of these pairs may be arranged to monitor the four brake units 16.

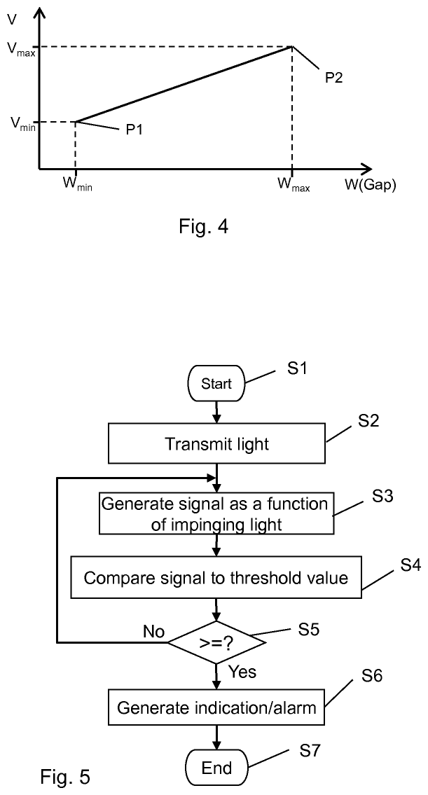

With reference to FIG. 4, a description of certain aspects of using the optical monitoring system 40 in accordance with the technology described herein follows. FIG. 4 is a schematic graph that illustrates a voltage V as a function of a width W(Gap) of the gap 39. Before the first use of the brake linings 20, 21 the width W(Gap) of the gap 39 is the smallest (Wₘᵢₙ) because the brake linings 20, 21 have their original thickness. Then, if the light source 41 is activated and light passes through the gap 39, the light detector 42 detects a certain amount of photons that cause the light detector 42 to output a certain voltage (Vₘᵢₙ). As the brake linings 20, 21 wear over time, the gap 39 widens, i. e., the width W(Gap) of the gap 39 increases, when the service brake 15 is in the lifted position. The widening of the gap 39 is directly proportional to the wear of the brake linings 20, 21. As a result thereof, more photons pass through the gap 39 and impinge on the light detector 42; hence, the voltage output by the light detector 42 increases. The voltage output is essentially proportional to the amount of photons impinging on the light detector 42. The graph shown in FIG. 2, therefore, is about linear and has a positive slope between a point P1 (Vₘᵢₙ, Wₘᵢₙ) and a point P2 (Vₘₐₓ, Wₘₐₓ).

In the illustrated embodiment of FIG. 1, the brake control 3 monitors the voltage output by the light detector 42. For that purpose, the brake control 3 includes a processor 43 and memory. The memory may store a predetermined threshold value for the voltage. This threshold value corresponds to a maximum width of the gap 39, i. e., a minimum thickness of the lining 21. In FIG. 2, the threshold value for the voltage is illustrated as Vₘₐₓ, and the minimum thickness of the lining 21 is illustrated as Wₘᵢₙ.

The processor 43 executes a measurement program that activates the light source 41, compares the voltage output of the light detector 42 with the stored threshold value (Vₘₐₓ) and generates for example a digital output, either a logical “0” or a logical “1”. The logical “1”, as one example of an indication, may indicate that the voltage output by the light detector 42 is equal to or greater than the threshold value (Vₘₐₓ), in which case the logical “1” is interpreted as an alarm signal. The logical “0” may indicate that the voltage output by the light detector 42 is lower than the threshold value (Vₘₐₓ). In one embodiment, the logical “1” may activate a red LED to warn of worn brake linings 20, 21, and the logical “0” may activate a green LED to indicate that the brake linings 20, 21 are still in good condition. Such LEDs may be arranged within the optical monitoring system 40, at the brake system 3, or at other locations of the drive and brake system 2. In another embodiment, the digital output may be fed to the brake system 3 and/or to a remote service station. In response to an alarm signal, the elevator system may be caused to come to a safe and controlled stop, and/or a service technician may be called to service the elevator system, for example, by means of a service request message. The service technician can then inspect the service brake 15 and its linings 20, 21. If the service technician confirms that the linings 20, 21 are worn, the linings 20, 21 are replaced with new ones.

In one embodiment, the measurement program operates according to a predetermined routine. For example, the processor 43 may activate the light source 41 each time the service brake 15 is opened after having been closed, or each time the elevator is in a stand-by mode. For that purpose, the processor 43 receives status information from the brake control 3 and/or an elevator control. In another embodiment, the measurement program may be triggered manually on site by a service technician. The processor 43 may operate the light source 41 in a continuous mode, but compares the voltage output of the light detector 42 with the stored threshold value (Vₘₐₓ) only then when the brake control 3 signals that the service brake 15 is not closed.

With the understanding of the general structure of the service brake 15 and the optical monitoring system 40 and certain features of their components described with reference to FIGS. 1, 2a, 2b, and 3, a description of how one embodiment of the optical monitoring system 40 operates follows with reference to FIG. 5. FIG. 5 shows a flow diagram of one embodiment of a method of monitoring the service brake 15 and its brake linings 20, 21. It is contemplated that in another illustration some of the shown steps may be merged into a single step, and a step may be split into two or more steps. The flow diagram starts at a step S1 and ends at a step S7.

Proceeding to a step S2, the optical monitoring system 40 is activated to emit light through the gap 39 (FIGS. 1, 2a, 3) or towards the edge region 55 (FIG. 6). More particularly, the processor 43 drives the light source 41 according to the above described procedure.

Proceeding to a step S3, the optical monitoring system 40 generates a signal as a function of impinging light, either having passed through the gap 39 or being reflected by the edge region 55. The light detector 42 converts the impinging light into an electrical signal having a voltage of a value that is proportional to the light intensity.

Proceeding to steps S4 and S5, the processor 43 receives the signal generated in step S3 and compares it to a stored threshold value (Vₘₐₓ). If the signal is equal to or greater than the threshold value (Vₘₐₓ), the method proceeds along the YES branch to a step S6. If this is not the case, the method returns along the NO branch to step S3.

In step S6, the processor 43 generates an indication (or alarm) that indicates that the signal has a value that is equal to or greater than the predetermined threshold value (Vₘₐₓ). That indication signifies that the thickness of the linings 20, 21 reached its minimum thickness. Measures to be taken subsequent to that indication are described above.

The embodiments described with reference to FIGS. 1, 2a, 2b and 3 are based on detecting light that passes through the gap 39 to obtain an indication of the thickness of the brake linings 20, 21. In another embodiment, an indication of the thickness of the brake linings 20, 21 can be obtained by detecting light reflected on the brake lining 20, 21. FIG. 6 shows an illustration of an embodiment of an optical monitoring system 40 based on detecting light reflected on the brake lining 21. The light source 41 and the light detector 42 are arranged next to each other in proximity of the brake lining 21, for example, side by side as shown in FIG. 6.

The light source 41 emits light (preferably laser light) that is directed towards an edge region 55 of the brake lining 21. The edge region 55 is at a front (wear) side of the brake lining 21 that acts upon the disk brake 22. The edge region 55 reflects incident light at an angle towards the light detector 42. Light emitted from the light source 41 is indicated through an arrow 50, and reflected light is indicated through an arrow 51. In one embodiment, the edge region 55 has a surface to which a reflective material is applied. The reflective material may be paint or a liner (e.g. a metal foil), both providing for a desired reflectance. Similar to the embodiment of FIG. 3, the reflective material is selected according to the light used (i.e., visible or nonvisible). The reflective surface can also be made with a gradient to provide degrees of reflectivity to create gradual intensity of reflected light. However, it is contemplated that the edge region 55 may have a sufficient reflectance on its own, for example, achieved through polishing, without having to apply the reflective material.

The edge region 55 and any applied reflective material are subject to wear during use of the brake lining 21. When the brake lining 21 is new, the area of the edge region's reflective surface (defined through a polished area or an area covered by reflective material) is at a maximum, and the highest light intensity is reflected to the light detector 42. Over time and with decreasing surface area due to wear, the light intensity of reflected light decreases. Similar to the above described embodiments, a threshold value may be defined that corresponds to a minimum light intensity when the brake lining 21 is due for replacement.

Referring again to the embodiments of FIGS. 1, 2a, 2b and 3, the optical monitoring system 40 and its monitoring of the output of the light detector 42 may not only be used to determine when the brake linings 20, 21 are due for replacement. In an additional embodiment, the output of the light detector 42 is used as an indicator of proper brake control during the stopping, and restarting of the elevator system 1. For example, in the elevator system 1 the elevator car 4 is stopped and held at a landing completely by electrically controlling the torque of an elevator drive 9. In that case, the service brake 15 is in its fully closed (seated) position. Determining the output of the light detector 42 at that time leads to a voltage Vmin(1) that indicates the fully closed position of the brake. That voltage Vmin(1) can then be used by the brake controller 3 to generate a signal that causes electrical power to be removed from the elevator drive 9 and to rely on the full torque of the brake 15 to hold the elevator car 4 at the landing.

The service brake 15 may be set to varying degrees of being opened (lifted). These degrees of partial lifting lead to corresponding voltages Vmin(2), Vmin(3) . . . Vmin(n) output by the light detector 42. These voltages indicate degrees of partial lifting of the service brake 15 and availability of brake torque. Such information and brake control is typically useful during the starting or preparation to run phases of the elevator system 1. In some elevator motor controls, a dwell time is required for the elevator motor to build full holding and running torque. An advantage of having a signal feedback from the service brake 15 that it has partially lifted is in the coordination of the building of elevator motor torque so that the elevator may be prepared to run at the earliest possible time, rather than wait for the sequential building of motor torque and then the lifting of the service brake 15. Such coordination may also lead to improved energy savings over other methods that involve providing continuous power to the elevator motor while at a landing.

For the sake of completeness, a description of additional structural and functional features of the elevator system 1 follows with reference to FIG. 1, to the extent believed to be helpful in understanding the environment in which the brake monitoring technology is used. The driving and braking system 2 also has a rotational-speed sensor 30, which is connected with the brake control 3 via a signal conductor 31. In this exemplary embodiment, the rotational-speed sensor 30 is arranged on the drive shaft 10 of the drive machine 9. Via the rotational-speed sensor 30, the brake control 3 registers the momentary rotational speed of the drive machine 9. Further, the brake control 3 is connected with the drive machine 9 via a signal conductor 32. This allows the brake control 3 to register a braking torque of the drive machine 9. Hence, operating parameters of the drive machine 9 are at least indirectly registerable. Hence, the brake control 3 can take account of such operating parameters in its controlling function.

In addition, the brake control 3 contains a safety device 33. The safety device 33 can be a part of a safety system, or be integrated into a safety system of the passenger transportation system 1. Via a signal conductor 34, the safety system 33 is connected with the frequency converter 11 as well as with the brake control 3.

The passenger transportation system 1 of the exemplary embodiment has an elevator car 4 and a traction sheave 5. Further provided is at least one suspension element 6, which at one end is connected with the elevator car 4 and at the other end with a counterweight 7. The suspension element 6 is passed over the traction sheave 5. In one embodiment, the suspension element 6 can be a round steel or aramid rope. In another embodiment, the suspension element 6 includes several steel cords embedded in a polyurethane material forming a flat belt-like structure. The elevator car 4, the suspension element 6, the counterweight 7, and the traction sheave 5 belong to the moving parts of the elevator system, as is represented in relation to the suspension element 6 with a velocity V_{c}(t) and a braking force F_{B}(t). Through the braking force F_{B}(t), the velocity V_{c}(t) of the elevator car 4 can be reduced. The braking deceleration which hereupon occurs, in other words the acceleration in the direction opposite to the velocity V_{c}(t), acts, for example, on a user 8 who is present in the car 4. For simplification, further components, which serve, for example, to guide the elevator car 4 along its path, are omitted from the illustration.

The passenger transportation system 1 has a drive machine 9 with a drive motor. Depending on the embodiment of the passenger transportation system 1, in addition to the drive motor, the drive machine 9 may also have a gear. By means of the drive machine 9, the traction sheave 5, and, via the traction sheave 5, the suspension element 6, the counterweight 7, and the elevator car 4, can be driven. In the present exemplary embodiment, the traction sheave 5 turns in counterclockwise direction, as a result of which the elevator car 4 moves along its path with a velocity V_{c}(t) downwards, and the counterweight 7 upwards.

Further, a frequency converter 11 is provided, which is connected with a power-supply network, or current network, 12 by a conductor line 35. The frequency converter 11 provides a power supply to the drive machine 9. Via a signal conductor 13, which may be realized by means of a bus system or similar, the frequency converter 11 is connected with the brake control 3 of the driving and braking system 2. The brake control 3 thus makes use of the frequency converter 11 to switch the drive machine 9 into a motor-brake operating mode. In the motor-brake operating mode, the drive machine 9, or the drive motor 9, acts as the motor brake. Hence, the brake control 3 can use the drive machine 9, which is already extant, to drive the passenger transportation system 1, and the frequency converter 11, for braking, without increasing the number of components that are required.

When a braking, in particular an emergency stop, is triggered, the brake control 3 switches the drive machine 9 into a motor-brake operating mode. In the motor-brake operating mode, the drive machine 9 acts as motor brake. An emergency stop is triggered, for example, when a safety circuit 36 acts on the brake control 3 by means of an activation signal. In FIG. 1, the safety circuit 36 is represented schematically as a unit. The safety circuit 36 can, for example, have an array of switches or sensors that are connected in series, which monitor the various safety-relevant points of the passenger transportation system 1. As soon as only one of these not-shown switches of the safety circuit 36 is opened, the safety circuit 36 is interrupted and this interruption is transmitted to the brake control 3 as an activation signal. By means of this switch of the safety circuit 36, for example, an opening of a door of the elevator car 4, an opening of at least one door that is provided on the floors for the passenger transportation system 1, and further suchlike, can be monitored.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A brake system for a passenger transportation system comprising:
a brake lining;
a brake surface, wherein a gap exists between the brake lining and the brake surface when the brake system is in an open position;
an optical monitoring system having a light source arranged to emit light towards at least one of the gap and the brake lining, and having a light detector arranged in a light path of the emitted light, the light detector generating an electrical signal as a function of an amount of the emitted light impinging on the light detector; and
a processor coupled to the optical monitoring system to receive the electrical signal and to generate a predetermined indication if the electrical signal indicates a value that is equal to or greater than a predetermined threshold value.

17. The brake system according to claim 16 wherein the light source and the light detector are arranged on opposite sides of the gap and the light path extends through the gap, wherein the brake lining blocks the light path in a closed position of the brake system.

18. The brake system according to claim 16 wherein the optical monitoring system includes a reflector arranged in the light path, the light source and the light detector being are arranged on one side of the gap and the reflector being arranged on an opposite side of the gap, the reflector reflecting the emitted light passing through the gap towards the gap, and the light detector generating the electrical signal as a function of the reflected emitted light.

19. The brake system according to claim 18 wherein the reflector has a gradient reflective surface.

20. The brake system of claim 16 wherein the brake lining has an edge region at a front side of the brake lining that acts upon the brake surface, the light source and the light detector being arranged in proximity to the edge region, the light source emitting the light toward the edge region and the edge region reflecting the emitted light toward the light detector, and the light detector generating the electrical signal as a function of the reflected emitted light.

21. The brake system according to claim 20 wherein the edge region includes one of a polished surface and a surface with applied reflective material that reflects the emitted light.

22. The brake system according to claim 20 wherein the edge region includes a gradient reflective surface that reflects the emitted light.

23. The brake system according to claim 16 wherein the processor generates a drive signal having a predetermined frequency to drive the light source to emit the light modulated according to the predetermined frequency, and wherein the processor operates the light detector to detect the emitted light according to the predetermined frequency.

24. The brake system according to claim 16 wherein the brake surface is one of a lateral surface of a cylinder-shaped brake disk and a cap surface of the cylinder-shaped brake disk.

25. A method of monitoring a brake system of a passenger transportation system, wherein the brake system includes a brake lining and a brake surface, wherein a gap exists between the brake lining and the brake surface when the brake system is in an open position, comprising the steps of:
activating a light source of an optical monitoring system to emit light towards at least one of the gap and the brake lining;
generating from a light detector, the light detector being arranged in a light path of the emitted light and included in the optical monitoring system, an electrical signal as a function of the emitted light impinging on the light detector; and
generating from a processor a predetermined indication if the electrical signal indicates a value that is equal to or greater than a predetermined threshold value.

26. The method according to claim 25 including generating from the processor a drive signal having a predetermined frequency to drive the light source to emit the light modulated according to the predetermined frequency, and operating the light detector to detect the emitted light according to the predetermined frequency.

27. The method according to claim 25 including stopping operation of the passenger transportation system in response to the generated predetermined indication.

28. The method according to claim 25 including generating a service request message in response to the generated predetermined indication.

29. The method according to claim 25 including determining the electrical signal when the brake system is in a fully closed position, and using the determined electrical signal to control supply of electrical power to a drive of the passenger transport system.

30. The method according to claim 25 including setting the brake system to a partially open position, determining the electrical signal at the partially open position and using the determined electrical signal to coordinate buildup of motor torque of a drive of the passenger transport system.
